(19) United States
(12) Patent Application Publication
(10) Pub. No.: US 2025/0128462 A1
(43) Pub. Date: Apr. 24, 2025

(54) MULTILAYER FILMS READILY DISINTEGRATING IN A MARINE ENVIRONMENT

(71) Applicant: Novamont S.p.A., Novara (IT)

(72) Inventors: Pier Simone INGUI', Novara (IT); Tiziana MILIZIA, Novara (IT); Claudio RUSSO, Novara (IT)

(73) Assignee: Novamont S.p.A., Novara (IT)

(21) Appl. No.: 18/836,050

(22) PCT Filed: Feb. 9, 2023
(86) PCT No.: PCT/EP2023/053212

§ 371 Date: Aug. 6, 2024

(30) Foreign Application Priority Data
Feb. 10, 2022 (IT) 102022000002468

(51) Int. Cl. B29C 48/00; B29C 48/08; B29C 48/21; B29K 67/00; B29K 509/08

(52) U.S. Cl. CPC B29C 48/022; B29C 48/0017; B29C 48/08; B29C 48/21; B29K 2067/046; B29K 2067/06; B29K 2509/08; B29K 2995/0018; B29K 2995/006; B29K 2995/0077

(57) ABSTRACT

Multilayer films which are highly biodegradable in a marine environment and highly disintegratable in domestic composting comprising an aliphatic polyester, an aliphatic-aromatic polyester, one or more lactic acid polyesters and optionally an inorganic filler, a cross-linking agent and/or a chain extender.

The present invention relates to a polymer composition particularly suitable for use in the production of films which are highly biodegradable in a marine environment and highly disintegrable in Home Composting.

Nowadays the problem of biodegradation in the marine environment is of enormous importance.

It is well known that any substance, material or product released in nature creates a potential ecological risk, and this is even more serious if in the marine environment.

The uncontrolled release of plastics products into the marine environment, regardless of biodegradability, causes enormous damage and therefore the end of life of compostable products must continue to be that for which they were designed: industrial composting through the differentiated collection and recovery of kitchen and garden waste, with compost becoming an indispensable tool for solving the problem of degradation of the soil, which is increasingly poor in carbon and therefore increasingly infertile.

However, if, as unfortunately happens with any packaging materials (glass, aluminium, paper, etc.), a plastics product is abandoned in nature, it is desirable that it should biodegrade as quickly as possible to avoid environmental damage.

For this reason, there is a particular need for polymer compositions that are biodegradable, compostable, and can be used for films that can quickly biodegrade in a marine environment. Polymer compositions that can disintegrate in a compostable aerobic environment at a temperature of 28° C., so that after use they can be treated in home composting, and that are also biodegradable in seawater, so that they may be disposed of in the sea through the action of micro-organisms in the water, are particularly desirable.

These characteristics are not the only essential ones: films obtained from these compositions must have excellent mechanical properties, such as stiffness and tensile strength, as well as optimal optical properties such as transparency, for proper commercial use.

For example, WO/2018/181500 and WO/2017/087658 describe the use of compositions in which polyhydroxyalkanoates (PHA) and aliphatic aromatic polyesters or polybutylene succinate are combined to produce films. But in this case, they exhibit low biodegradability at room temperature and low biodegradability in the marine environment.

JP2021055084A describes a film made from a marine biodegradable polyester comprising an aliphatic polyester composition comprising: an aliphatic polyester resin (A) containing a repeating unit derived from an aliphatic diol and a repeating unit derived from an aliphatic dicarboxylic acid as the main constituent unit, a polyhydroxyalkanoate (B) and an inorganic filler (C), in which the polyhydroxyalkanoate (B) contains the 3-hydroxybutyrate unit and the 3-hydroxyhexanoate unit as the main constituent unit, and the mass ratio of the aliphatic polyester composition (A) to the polyhydroxyalkanoate (B) is 95/5 to 70/30. These films have relatively poor transparency properties.

Moreover, in the compositions described in JP2021055084A, the amount of polyhydroxyalkanoate is no more than 30% because it is known that this material does not permit high biodegradability.

The problem underlying the present invention is therefore to provide films which are characterised by being able to both disintegrate readily at low temperature under domestic composting conditions and biodegrade readily in a marine environment, and having optimal mechanical and optical properties.

It has now surprisingly been found that it is possible to solve this problem by means of a polymer composition made of aliphatic polyesters, which leads to increased low-temperature disintegration of films obtained from such a composition, while maintaining, if not improving, the optical and mechanical properties.

Furthermore, such a composition can easily be used in the blown film process without requiring modifications to existing equipment.

One object of the present invention is to provide a polymer composition to produce films that may be single-layer or multi-layer.

The present invention relates in particular to a polymer composition comprising, with respect to the total composition:
i) 10-49% by weight, preferably 14-45%, even more preferably 24-40% or even more preferably 35-40% by weight, relative to the sum of components i.-v., of at least one aliphatic polyester i. comprising:
   a) a dicarboxylic component comprising, compared to the total dicarboxylic component:
      a1) 60-95% in moles, preferably 70-85% in moles, of units derived from succinic acid;
      a2) 5-40% in moles, preferably 15-30% in moles, of units derived from at least one saturated dicarboxylic acid having a number of carbon atoms greater than 4;
   b) a diol component comprising, compared to the total diol component:
      b1) 95-100% in moles of units derived from 1,4-butanediol;
      b2) 0-5% in moles of units derived from at least one saturated aliphatic diol other than 1,4-butanediol.
ii) 0-15% by weight, preferably 1-5% by weight, of at least one aliphatic-aromatic polyester ii. comprising:
   c) a dicarboxylic component comprising, compared to the total dicarboxylic component:
      c1) 42-60% in moles, preferably 45-49.5% in moles, of units derived from at least one aromatic dicarboxylic acid;
      c2) 58-40% in moles, preferably 55-50.5% in moles, of units derived from at least one saturated aliphatic dicarboxylic acid.
   d) a diol component comprising, compared to the total diol component:
      d1) 95-100% in moles of units derived from at least one saturated aliphatic diol;
      d2) 0-5% in moles of units derived from at least one unsaturated aliphatic diol.
iii) 51-90% by weight, preferably 55-86% by weight, even more preferably 60-76% by weight or even more preferably 60-65% by weight, with respect to the sum of components i.-v., of at least one or more lactic acid polyesters.
iv) 0-1.5% by weight, preferably 0.1-1.2% by weight, even more preferably 0.2-0.5% by weight, relative to the sum of components i.-v., of at least one inorganic filler.
v) 0-2.5% by weight, more preferably 0.02-1.5% by weight, even more preferably 0.1-1.0% by weight, with respect to the sum of components i.-v., of at least one crosslinking agent and/or chain extender comprising at least one di- and/or polyfunctional compound bearing groups selected from isocyanate, peroxide, carbodiimide, isocyanurate, oxazoline, epoxide, anhydride, divinyl ether and mixtures thereof.

The polymer composition described above may be used to produce monolayer films or multilayer films.

With regard to the aliphatic polyesters of the composition according to the present invention, these are present between 10-49% by weight, preferably 14-45%, even more preferably 24-40% or even more preferably 35-40% by weight, of the total polymer composition i.-v. With respect to the aliphatic polyesters i. of the composition according to the present invention, these comprise a dicarboxylic component comprising, with respect to the total dicarboxylic component, 60-95% in moles, preferably 70-85% in moles, of units derived from succinic acid (component a1), and 5-40% in moles, preferably 15-30% in moles, of units derived from at least one saturated dicarboxylic acid having a number of carbon atoms greater than 4 (component a2).

Saturated aliphatic dicarboxylic acids other than succinic acid (component a2) of aliphatic polyester i. of the composition according to the present invention are preferably selected from C₅-C₂₄, more preferably C₅-C₁₃, more preferably C₅-C₁₁, saturated dicarboxylic acids, their C₁-C₂₄, more preferably C₁-C₄, alkyl esters, their salts and mixtures thereof. Preferably, the saturated aliphatic dicarboxylic acids other than succinic acid are selected from: 2-ethylsuccinic acid, glutaric acid, 2-methylglutaric acid, adipic acid, pimelic acid, suberic acid, azelaic acid, sebacic acid, undecanedioic acid, dodecanedioic acid, brassylic acid and their C₁-C₂₄ alkyl esters. In a preferred embodiment of the present invention, the saturated aliphatic dicarboxylic acid other than succinic acid is selected from the group consisting of adipic acid, azelaic acid, sebacic acid and mixtures thereof. In an even more preferred embodiment of the present invention, the saturated aliphatic dicarboxylic acid other than succinic acid is azelaic acid.

The dicarboxylic component of the aliphatic polyesters i. of the composition according to the present invention may comprise up to 5% unsaturated aliphatic dicarboxylic acids, preferably selected from the group consisting of itaconic acid, fumaric acid, 4-methylene-pimelic acid, 3,4-bis(methylene) nonanedioic acid, 5-methylene-nonanedioic acid, their C₁-C₂₄, preferably C₁-C₄, alkyl esters, their salts and mixtures thereof. In a preferred embodiment of the present invention the unsaturated aliphatic dicarboxylic acids comprise mixtures comprising at least 50% in moles, preferably more than 60% in moles, more preferably more than 65% in moles, of itaconic acid, its C₁-C₂₄, preferably C₁-C₄, esters. More preferably, said unsaturated aliphatic dicarboxylic acids consist of itaconic acid.

The diol component of the aliphatic polyesters i. of the composition according to the present invention may comprise up to 5% unsaturated aliphatic diols, preferably selected from the group consisting of cis 2-butene-1,4-diol, trans 2-butene-1,4-diol, 2-butyne-1,4-diol, cis 2-pentene-1,5-diol, trans 2-pentene-1,5-diol, 2-pentyne-1,5-diol, cis 2-hexene-1,6-diol, trans 2-hexene-1,6-diol, 2-hexyne-1,6-diol, cis 3-hexene-1,6-diol, trans 3-hexene-1,6-diol, 3-hexene-1,6-diol. In a particularly preferred embodiment, the aliphatic polyesters i. of the composition according to the present invention are selected from the group consisting of poly(1,4-butylene succinate-co-adipate), poly(1,4-butylene succinate-co-1,4-butylene azelate), poly(1,4-butylene succinate-co-1,4-butylene sebacate).

In an even more preferred embodiment, aliphatic polyester i. is poly(1,4-butylene succinate-co-1,4-butylene azelate).

The aliphatic polyesters i. of the composition according to the present invention may further advantageously comprise repetitive units derived from at least one hydroxy acid in an amount of between 0-49%, preferably between 0-30%, in moles relative to the total moles of dicarboxylic component. Examples of suitable hydroxy acids are glycolic acid, hydroxybutyric acid, hydroxycaproic acid, hydroxyvaleric acid, 7-hydroxyheptanoic acid, 8-hydroxycaproic acid, 9-hydroxynonanoic acid, lactic acid or lactide. The hydroxy acids may be inserted into the chain as such or they may also be reacted with diacids or diols beforehand.

Long difunctional molecules with non-terminal functional groups may also be added, in quantities not exceeding 10% in moles to the total moles of dicarboxylic component. Examples are dimer acids, ricinoleic acid and acids with epoxy functional groups, and also polyoxyethylenes with molecular weights of between 200 and 10000.

Diamines, amino acids, and amino-alcohols may also be present in percentages of up to 30% in moles with respect to the total moles of dicarboxylic component.

In the process of preparing the aliphatic polyesters i. of the composition according to the present invention, one or more polyfunctional molecules may also advantageously be added, in amounts of between 0.1 and 3.0 moles to the total moles of dicarboxylic component (as well as any hydroxy acids), in order to obtain branched products. Examples of these molecules are glycerol, pentaerythritol, trimethylolpropane, citric acid, dipentaerythritol, monoanhydrosorbitol, monohydromannitol, acid triglycerides, and polyglycerols.

The molecular weight Mn of the aliphatic polyesters i. of the composition according to the present invention is preferably ≥20000, more preferably ≥40000. With regard to the polydispersity index of the molecular weights Mw/Mn, this is preferably between 1.5 and 10, more preferably between 1.6 and 5 and even more preferably between 1.8 and 3.5.

The molecular weights Mn and Mw may be measured by Gel Permeation Chromatography (GPC). The determination may be carried out with the chromatographic system maintained at 40° C., using a set of two columns in series (particle diameter 5 μm and 3 μm with mixed porosity), a refractive index detector, chloroform as eluent (flow rate 0.5 ml/min) and using polystyrene as reference standard.

The Melt Flow Rate (MFR) of aliphatic polyesters i. is preferably between 500 and 1 g/10 min, more preferably between 100 and 3 g/10 min, even more preferably between 15 and 4 g/10 min (measurement carried out at 190° C./2.16 kg according to ISO 1133-1 “Plastics—determination of the melt mass-flow rate (MFR) and melt volume flow rate (MVR) of thermoplastics—Part 1: Standard method”).

The terminal acid groups content of the aliphatic polyesters i. of the composition according to the present invention is preferably between 15 and 160 meq/kg, more preferably between 30 and 100 meq/kg and even more preferably between 40 and 60 meq/kg.

The terminal acid groups content may be measured as follows: 1.5-3 g of the polyester is placed in a 100 ml conical flask together with 60 ml of chloroform. After complete dissolution of the polyester, 25 ml 2-propanol is added and, immediately before analysis, 1 ml deionised water is added. The resulting solution is titrated with a previously standardised solution of NaOH in ethanol. An appropriate indicator, such as a glass electrode for acid-base titrations in non-aqueous solvents, is used to determine the equivalence point of the titration. The terminal acid groups content is calculated on the basis of the consumption of NaOH solution in ethanol according to the following equation:

$$Terminal acid groups content ( meq / kg polymer ) = \frac{⌊ ( {V}_{e q} - {V}_{b} ) \cdot T ⌋ \cdot 1000}{P}$$

where: V_{eq}=ml of NaOH solution in ethanol at the equivalence point of the sample titration;
   V_{b}=ml of NaOH solution in ethanol required to reach pH=9.5 during blank titration;
   T=concentration of NaOH solution in ethanol expressed in mol/litre;
   P=weight of sample in grams.

Preferably, the aliphatic polyesters i. of the composition according to the present invention have an inherent viscosity (measured with an Ubbelohde viscometer for solutions in CHCl₃ of concentration 0.2 g/dl at 25° C.) greater than 0.3 dl/g, preferably between 0.3 and 2 dl/g, more preferably between 0.4 and 1.3 dl/g.

With regard to the aliphatic-aromatic polyesters ii. of the composition according to the present invention, these are present between 0 and 15%, preferably between 1% and 5% of the total polymer composition i.-v.

The aliphatic-aromatic polyesters ii. comprise a dicarboxylic component comprising, with respect to the total dicarboxylic component, 42-60% in moles, preferably 45-49.5% in moles of units derived from at least one aromatic dicarboxylic acid (component c1), and 58-40% in moles, preferably 55-50.5% in moles, of units derived from at least one saturated aliphatic dicarboxylic acid (component c2).

The aromatic dicarboxylic acids (component c1) of the aliphatic-aromatic polyesters ii. of the composition according to the present invention are preferably selected from aromatic dicarboxylic acids of the phthalic acid type, preferably terephthalic acid or isophthalic acid, more preferably terephthalic acid and heterocyclic aromatic dicarboxylic compounds, preferably 2,5-furandicarboxylic acid, 2,4-furandicarboxylic acid, 2,3-furandicarboxylic acid, 3,4-furandicarboxylic acid, their esters, salts and mixtures thereof.

The saturated aliphatic dicarboxylic acids (component c2) of aliphatic-aromatic polyesters ii. are preferably selected from C₂-C₂₄, more preferably C₄-C₁₃, more preferably C₄-C₁₁, saturated dicarboxylic acids, their C₁-C₂₄, more preferably C₁-C₄, alkyl esters, their salts and mixtures thereof. Preferably, the saturated aliphatic dicarboxylic acids are selected from: succinic acid, 2-ethylsuccinic acid, glutaric acid, 2-methylglutaric acid, adipic acid, pimelic acid, suberic acid, azelaic acid, sebacic acid, undecanedioic acid, dodecanedioic acid, brassylic acid and their C₁-C₂₄ alkyl esters. Preferably said saturated dicarboxylic acids are selected from the group consisting of succinic acid, adipic acid, azelaic acid, sebacic acid, brassylic acid and their mixtures.

The dicarboxylic component of the aliphatic-aromatic polyesters ii. of the composition according to the present invention may comprise up to 5% of unsaturated aliphatic dicarboxylic acids, preferably selected from itaconic acid, fumaric acid, 4-methylene-pimelic acid, 3,4-bis (methylene) nonanedioic acid, 5-methylene-nonanedioic acid, their C₁-C₂₄, preferably C₁-C₄, alkyl esters, their salts and mixtures thereof.

In a preferred embodiment of the present invention, the unsaturated aliphatic dicarboxylic acids comprise mixtures comprising at least 50% in moles, preferably more than 60% in moles, more preferably more than 65% in moles, of itaconic acid, its C₁-C₂₄, more preferably C₁-C₄, esters. More preferably, the unsaturated aliphatic dicarboxylic acids consist of itaconic acid.

The diol component of the aliphatic-aromatic polyesters ii. of the composition according to the present invention comprises, with respect to the total diol component, 95-100% in moles, preferably 97-100% in moles, of units derived from at least one saturated aliphatic diol (component d1) and 0-5% in moles, preferably 0-3% in moles, with respect to the total diol component, of units derived from at least one unsaturated aliphatic diol (component d2).

The saturated aliphatic diols (component d1) of the aliphatic-aromatic polyesters ii. of the composition according to the present invention are preferably selected from the group consisting of 1,2-ethanediol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,1-undecanediol, 1,12-dodecanediol, 1,13-tridecanediol, 1,4-cyclohexanedimethanol, neopentylglycol, 2-methyl-1,3-propanediol, dianhydrosorbitol, dianhydromannitol, dianhydroiditol, cyclohexanediol, cyclohexanmethanediol, dialkylene glycols and polyalkylene glycols with molecular weights of 100-4000, such as polyethylene glycol, polypropylene glycol and mixtures thereof. Preferably, at least 50% in moles of the diol component comprises one or more diols selected from 1,2-ethanediol, 1,3-propanediol, 1,4-butanediol. In a preferred embodiment of the present invention the saturated aliphatic diol is derived from 1,4-butanediol. The unsaturated aliphatic diols (component d2) of the aliphatic-aromatic polyesters ii. of the composition according to the present invention are preferably selected from the group consisting of cis 2-butene-1,4-diol, trans 2-butene-1,4-diol, 2-butyne-1,4-diol, cis 2-pentene-1,5-diol, trans 2-pentene-1,5-diol, 2-pentyne-1,5-diol, cis 2-hexene-1,6-diol, trans 2-hexene-1,6-diol, 2-hexyne-1,6-diol, cis 3-hexene-1,6-diol, trans 3-hexene-1,6-diol, 3-hexene-1,6-diol. In a preferred embodiment, the aliphatic-aromatic polyesters ii. are preferably selected from the group consisting of: poly(1,4-butylene adipate-co-1,4-butylene terephthalate), poly(1,4-butylene sebacate-co-1,4-butylene terephthalate), poly(1,4-butylene azelate-co-1,4-butylene terephthalate), poly(1,4-butylene brassylate-co-1,4-butylene terephthalate), poly(1,4-butylene succinate-co-1,4-butylene terephthalate), poly(1,4-butylene adipate-co-1,4-butylene sebacate-co-1,4-butylene terephthalate), poly(1,4-butylene azelate-co-1,4-butylene sebacate-co-1,4-butylene terephthalate), poly(1,4-butylene adipate-co-1,4-butylene azelate-co-1,4-butylene terephthalate), poly(1,4-butylene succinate-co-1,4-butylene sebacate-co-1,4-butylene terephthalate), poly(1,4-butylene adipate-co-1,4-butylene succinate-co-1,4-butylene terephthalate), poly(1,4-butylene azelate-co-1,4-butylene succinate-co-1,4-butylene terephthalate).

The aliphatic-aromatic polyesters ii. may also advantageously comprise repetitive units derived from at least one hydroxy acid in an amount of 0-49%, preferably 0-30%, in moles with respect to the total moles of dicarboxylic component. Examples of suitable hydroxy acids are glycolic acid, hydroxybutyric acid, hydroxycaproic acid, hydroxyvaleric acid, 7-hydroxyheptanoic acid, 8-hydroxycaproic acid, 9-hydroxynonanoic acid, lactic acid or lactide. The hydroxy acids may be inserted into the chain as such or they may also be reacted with diacids or diols beforehand.

Long difunctional molecules with non-terminal functional groups may also be added, in quantities not exceeding 10% in moles to the total moles of dicarboxylic component. Examples are dimer acids, ricinoleic acid and acids with epoxy functional groups, and also polyoxyethylenes with molecular weights between 200 and 10000.

Diamines, amino acids, and amino-alcohols may also be present in percentages of up to 30% in moles with respect to the total moles of dicarboxylic component.

In the process of preparing the aliphatic-aromatic polyesters ii. of the composition according to the present invention, one or more polyfunctional molecules may also advantageously be added, in amounts of between 0.05 and 3% in moles to the total moles of dicarboxylic component (as well as any hydroxy acids), in order to obtain branched products. Examples of these molecules are glycerol, 1, pentaerythritol, trimethylolpropane, citric acid, dipentaerythritol, monoanhydrosorbitol, monohydromannitol, acid triglycerides, polyglycerols, etc. The molecular weight Mn of the aliphatic-aromatic polyesters ii. of the composition according to the present invention is preferably ≥20000, more preferably ≥40000. With regard to the polydispersity index of the molecular weights Mw/Mn, this is preferably between 1.5 and 10, more preferably between 1.6 and 5, and even more preferably between 1.8 and 2.7.

The molecular weights Mₙ and M_{w} may be measured using the method described for aliphatic polyesters i.

The Melt Flow Rate (MFR) of aliphatic-aromatic polyesters ii. is preferably between 500 and 1 g/10 min, more preferably between 100 and 3 g/10 min, even more preferably between 15 and 3 g/10 min (measurement carried out at 190° C./2.16 kg according to ISO 1133-1 “Plastics—determination of the melt mass-flow rate (MFR) and melt volume flow rate (MVR) of thermoplastics—Part 1: Standard method”).

The terminal acid groups content of the aliphatic-aromatic polyesters ii. of the composition according to the present invention is preferably less than 100 meq/kg, preferably less than 60 meq/kg and even more preferably less than 40 meq/kg.

The terminal acid groups content may be measured according to the method described for aliphatic polyester i.

Preferably, the aliphatic-aromatic polyesters ii. of the composition according to the present invention have an inherent viscosity (measured with an Ubbelohde viscometer for solutions in CHCl₃ of concentration 0.2 g/dl at 25° C.) greater than 0.3 dl/g, preferably between 0.3 and 2.0 dl/g, more preferably between 0.4 and 1.1 dl/g.

The polyesters i. and ii. of the composition according to the present invention may be synthesised according to any of the processes known in the state of the art. In particular, they may advantageously be obtained by a polycondensation reaction.

Advantageously, the synthesis process may be conducted in the presence of a suitable catalyst. Suitable catalysts include organometallic Tin compounds, e.g., stannoic acid derivatives, Titanium compounds, e.g., ortho-butyl titanate, Aluminium compounds, e.g., Al-triisopropyl, Antimony and Zinc and Zirconium compounds and mixtures thereof.

Examples of synthetic processes that may advantageously be used for the preparation of polyesters are described in international patent application PCT2016050963.

In addition to components i. and ii., the composition according to the present invention comprises 51-90% by weight, preferably 55-86%, even more preferably 60-76% or even more preferably 60-65% by weight, of at least one or more lactic acid polyesters (component iii.), with respect to the total i.-v. composition.

The lactic acid polyesters are selected from the group consisting of poly L-lactic acid, poly D-lactic acid, poly D-L lactic acid stereo complex, copolymers comprising more than 50% in moles of said lactic acid polyesters and their mixtures.

Particularly preferred are lactic acid polyesters containing at least 95% by weight of repetitive units derived from L-lactic or D-lactic acid or combinations thereof, with a molecular weight Mw greater than 50000 and with a shear viscosity of between 50 and 250 Pa·s preferably between 80 and 200 Pa·s (measured according to ASTM standard D3835 at T=190° C., shear rate=1000 s⁻¹, D=1 mm, L/D=10 on the dried polymer (water content less than 400 ppm)).

In a particularly preferred embodiment of the present invention, the lactic acid polyester comprises at least 96% by weight of units derived from L-lactic acid, ≤4% by weight of repetitive units derived from D-lactic acid, has a Melting Temperature in the range 160-180° C. a Glass Transition Temperature (Tg) in the range 55-65° C. and an MFR (measured according to ASTM-D1238 standard at 190° C. and 2.16 kg on the dried polymer (water content less than 400 ppm)) in the range 10-50 g/10 min. Commercial examples of lactic acid polyesters with these properties include the Ingeo™ brand products Biopolymer 3251D and Luminy® L105. The composition according to the present invention preferably comprises 0-1.5% by weight, preferably between 0.1 and 1.2%, even more preferably between 0.2 and 0.5%, of the sum of the i.-v. components of at least one inorganic filler (component iv), which is preferably selected from the group consisting of kaolin, barytes, clay, talc, calcium and magnesium, iron and lead carbonates, aluminium hydroxide, kieselguhr, aluminium sulfate, barium sulfate, silica, mica, titanium dioxide and wollastonite.

In a preferred embodiment of the present invention, the inorganic filler comprises one or more of talc, mica, calcium carbonate, silica or mixtures thereof, present in the form of particles having an arithmetic average diameter of less than 10 μm measured with respect to the major axis of the particles, more preferably having an arithmetic average diameter of less than 2 μm (measured according to ASTM 13320). In a preferred aspect of the invention, the inorganic filler is silica.

The composition according to the present invention preferably comprises 0-2.5% by weight, more preferably 0.02-1.5% by weight, even more preferably 0.1-1.0% by weight of the sum of components i.-v., of at least one cross-linking agent and/or chain extender (component v.). Said component v. improves stability to hydrolysis and is selected from di- and/or polyfunctional compounds bearing groups selected from one or more of the following: isocyanate, peroxide, carbodiimide, isocyanurate, oxazoline, epoxide, anhydride, divinyl ether and mixtures thereof. Preferably, the crosslinking agent and/or chain extender comprises at least one di- and/or polyfunctional compound bearing epoxide or carbodiimide groups.

Preferably, the crosslinking agent and/or chain extender comprises at least one di- and/or polyfunctional compound bearing isocyanate groups. More preferably, the crosslinking agent and/or chain extender comprises at least 25% by weight of one or more di- and/or polyfunctional compounds bearing isocyanate groups. Especially preferred are mixtures of di- and/or polyfunctional compounds bearing isocyanate groups with di- and/or polyfunctional compounds bearing epoxide groups, even more preferably comprising at least 75% by weight of di- and/or polyfunctional compounds bearing isocyanate groups.

Preferably, the di- and polyfunctional compounds bearing isocyanate groups are selected from the group consisting of p-phenylene diisocyanate, 2,4-toluene diisocyanate, 2,6-toluene diisocyanate, 4,4-diphenylmethane diisocyanate, 1,3-phenylene-4-chloro diisocyanate. 1,5-naphthalene diisocyanate, 4,4-diphenylene diisocyanate, 3,3′-dimethyl-4,4-diphenylmethane diisocyanate, 3-methyl-4,4′-diphenylmethane diisocyanate, diphenyl ether diisocyanate, 2,4-cyclohexane diisocyanate, 2,3-cyclohexane diisocyanate, 1-methyl 2,4-cyclohexyl diisocyanate, 1-methyl 2,6-cyclohexyl diisocyanate, bis-(isocyanate cyclohexyl) methane, 2,4,6-toluene triisocyanate, 2,4,4-diphenylether triisocyanate, polymethylene-polyphenyl-polyisocyanates, methylene diphenyl diisocyanate, triphenylmethane triisocyanate, 3,3′-dithiolylene-4,4-diisocyanate, 4,4′-methylene bis(2-methylphenyl isocyanate), hexamethylene diisocyanate, 1,3-cyclohexylene diisocyanate, 1,2-cyclohexylene diisocyanate and mixtures thereof. In a preferred embodiment, the compound bearing isocyanate groups is 4,4-diphenylmethane-diisocyanate.

With regard to di- and polyfunctional compounds bearing peroxide groups, these are preferably selected from the group consisting of benzoyl peroxide, lauroyl peroxide, isononanoyl peroxide, di-(t-butylperoxyisopropyl)benzene, t-butyl peroxide, dicumyl peroxide, alpha,alpha′-di(t-butylperoxy)diisopropylbenzene, 2,5-dimethyl-2,5-di(t-butylperoxy) hexane, t-butyl cumyl peroxide, di-t-butyl peroxide, 2,5-dimethyl-2,5-di(t-butylperoxy) hex-3-yne, di(4-t-butylcyclohexyl) peroxydicarbonate, dicetyl peroxydicarbonate, dimyristyl peroxydicarbonate, 3,6,9-triethyl-3,6,9-trimethyl-1,4,7-triperoxonane, di(2-ethylhexyl) peroxydicarbonate and mixtures thereof.

The di- and polyfunctional compounds bearing carbodiimide groups which are preferably used in the composition according to the present invention are selected from the group consisting of poly(cyclooctylene carbodiimide), poly(1,4-dimethylenecyclohexylene carbodiimide), poly(cyclohexylene carbodiimide), poly(ethylene carbodiimide), poly(butylene carbodiimide), poly(isobutylene carbodiimide), poly(nonylene carbodiimide), poly(dodecylene carbodiimide) poly(neopentylene carbodiimide), poly(1,4-dimethylene phenylene carbodiimide), poly(2,2′,6,6′, tetraisopropyldiphenylene carbodiimide) (Stabaxol® D), poly(2,4,6-triisolpropyl-1,3-phenylene carbodiimide) (Stabaxol® P-100), poly(2,6-diisopropyl-1,3-phenylene carbodiimide) (Stabaxol P), poly(tolyl carbodiimide), poly(4,4′-diphenylmethane carbodiimide), poly(3,3′-dimethyl-4,4′-biphenylene carbodiimide), poly(p-phenylene carbodiimide), poly(m-phenylene carbodiimide), poly(3,3′-dimethyl-4,4′-diphenylmethane carbodiimide), poly(naphthylene carbodiimide), poly(isophorone carbodiimide), poly(cumene carbodiimide), p-phenylene bis(ethylcarbodiimide), 1,6-hexamethylene bis(ethylcarbodiimide), 1,8-octamethylene bis(ethylcarbodiimide), 1,10-decamethylene bis(ethylcarbodiimide), 1,12 dodecamethylene bis(ethylcarbodiimide) and mixtures thereof.

Examples of di- and polyfunctional compounds bearing epoxide groups which may be advantageously used in the composition according to the present invention are all polyepoxides from epoxidised oils and/or styrene-glycidyl ether-methyl methacrylate, glycidyl ether-methyl methacrylate, included in a range of molecular weights between 1000 and 10000 and having a number of epoxides per molecule in the range from 1 to 30 and preferably between 5 and 25, and the epoxides selected from the group consisting of: diethylene glycol diglycidyl ether, polyethylene glycol diglycidyl ether, polyglycerol polyglycidyl ether, 1,2-epoxybutane, polyglycerol polyglycidyl ether, isoprene diepoxide, and cycloaliphatic diepoxides, 1,4-cyclohexanedimethanol diglycidyl ether, glycidyl 2-methylphenyl ether, glycerol propoxylatotriglycidyl ether, 1,4-butanediol diglycidyl ether, sorbitol polyglycidyl ether, glycerol diglycidyl ether, tetraglycidyl ether of meta-xylenediamine and diglycidyl ether of bisphenol A and mixtures thereof.

In a particularly preferred embodiment of the invention, the crosslinking agent and/or chain extender of the composition comprises compounds bearing isocyanate groups, preferably 4,4-diphenylmethane-diisocyanate, and/or bearing carbodiimide groups, and/or bearing epoxide groups, preferably of the styrene-glycidyl ether-methyl methacrylate type.

In a particularly preferred embodiment of the invention, the cross-linking agent and/or chain extender comprises compounds bearing epoxide groups of the styrene-glycidyl ether-methyl methacrylate type.

Along with the di- and polyfunctional compounds bearing isocyanate, peroxide, carbodiimide, isocyanurate, oxazoline, epoxide, anhydride and divinyl ether groups of the composition according to the present invention, catalysts may also be used to raise the reactivity of the reactive groups. In the case of polyepoxides, fatty acid salts are preferably used, even more preferably calcium and zinc stearates.

The inorganic filler (component iv.) and the cross-linking agent and/or chain extender (component v.) may be added during the extrusion process either directly in the desired final concentration or in the hopper as a “masterbatch”. By “masterbatch” in the present invention is meant a pellet based on an aliphatic-aromatic polyester (component ii.) or based on a lactic acid polyester (component iii.) with a high concentration of the crosslinking agent and/or chain extender or inorganic filler. The concentration of the additive in the masterbatch is usually between 10% and 15%. For example, Joncryl ADR4368CS comprising 10% by weight of styrene-glycidyl ether-methyl methacrylate copolymer (component v.) and 90% by weight of a lactic acid polyester (component iii.) is used in masterbatch mode.

The composition according to the present invention may contain an antifogging agent selected from the esters of a polyfunctional alcohol, preferably from the condensation products of a polyfunctional alcohol with a fatty acid, in which said antifogging agent is present in an amount of between 0.2 and 5%, preferably between 1 and 3% by weight, relative to the total weight of the composition. The antifogging agent is preferably selected from an ester of a fatty acid having 8 to 18 carbon atoms, more preferably 12 to 16 carbon atoms. Suitable compounds which may be used as an antifogging agent are polyglyceryl laurate, sorbitan monooleate, sorbitan trioleate and glycerine monopalmitate.

The composition according to the present invention preferably also contains at least one other component selected from the group consisting of plasticisers, UV stabilisers, lubricants, nucleating agents, surfactants, antistatic agents, pigments, flame retardant agents, compatibilising agents, lignin, organic acids, antioxidants, anti-mould agents, waxes, process aids and polymer components preferably selected from the group consisting of vinyl polymers, diacid diol polyesters other than polyesters i. and ii., polyamides, polyurethanes, polyureas, polycarbonates.

With regard to plasticisers, the composition according to the present invention preferably includes one or more plasticisers selected from the group consisting of phthalates, such as diisononyl phthalate, trimellitates, such as trimellitic acid esters with C₄-C₂₀ monoalcohols preferably selected from the group consisting of n-octanol and n-decanol, and aliphatic esters having the following structure:

R₁—O—C(O)—R₄—C(O)—[—O—R₂—O—C(O)—R₅—C(O)—]ₘ—O—R₃
in which
R₁ is selected from one or more of the groups constituted by H, linear and branched, saturated and unsaturated alkyl residues of the C₁-C₂₄ type, polyol residues esterified with C₁-C₂₄ monocarboxylic acids;
R₂ comprises —CH₂—C(CH₃)₂—CH₂— and alkylene C₂-C₈ groups and consists of at least 50 percent in moles of said —CH₂—C(CH₃)₂—CH₂— groups;
R₃ is selected from one or more of the groups constituted by H, linear and branched, saturated and unsaturated alkyl residues of the C₁-C₂₄ type, polyol residues esterified with C₁-C₂₄ monocarboxylic acids;
R₄ and R₅ are the same or different, comprise one or more of C₂-C₂₂, preferably C₂-C₁₁, more preferably C₄-C₉, alkylenes and consist of at least 50% in moles of C₇ alkylenes.

m is a number between 1-20, preferably 2-10, more preferably 3-7. Preferably, in said esters at least one of the R₁ and/or R₃ groups comprises polyol residues esterified with at least one C₁-C₂₄ monocarboxylic acid selected from the group consisting of stearic acid, palmitic acid, 9-ketostearic acid, 10-ketostearic acid and mixtures thereof preferably in an amount of ≥10% in moles, more preferably ≥20%, even more preferably ≥25% in moles, relative to the total amount of R₁ and/or R₃ groups. Examples of such aliphatic esters are described in Italian patent application PCT MI2014A000030 and applications PCT/EP2015/050336, PCT/EP2015/050338.

When present, selected plasticisers are preferably present up to 5% by weight, relative to the total weight of the composition.

Preferably, the lubricants are selected from esters and metal salts of fatty acids such as, for example, zinc stearate, calcium stearate, aluminium stearate and acetyl stearate. Preferably, the composition according to the present invention comprises up to 1% by weight of lubricants, more preferably up to 0.5% by weight, relative to the total weight of the composition.

Examples of nucleating agents include saccharin sodium salt, calcium silicate, sodium benzoate, calcium titanate, boron nitride, isotactic polypropylene, low molecular weight PLA. These additives are preferably added in amounts of up to 10% by weight and more preferably up to 5% by weight, relative to the total weight of the composition.

Pigments may also be added, if necessary, e.g., titanium dioxide, clays, copper phthalocyanine, silicates, iron oxides and hydroxides, carbon black, and magnesium oxide.

Preferred vinyl polymers include polyethylene, polypropylene, their copolymers, polyvinyl alcohol, polyvinyl acetate, polyethyl ethyl vinyl acetate and polyethylene vinyl alcohol, polystyrene, chlorinated vinyl polymers, polyacrylates.

With regard to the polyamides of the composition according to the present invention, these are preferably selected from the group consisting of polyamide 6 and 6,6, polyamide 9 and 9,9, polyamide 10 and 10,10, polyamide 11 and 11,11, polyamide 12 and 12,12 and their combinations of the type 6/9, 6/10, 6/11, 6/12 their mixtures and copolymers, both random and block.

Preferably, the polycarbonates of the composition according to the present invention are selected from the group consisting of polyalkylene carbonates, more preferably polyethylene carbonates, polypropylene carbonates, polybutylene carbonates their mixtures and both random and block copolymers.

Among the polyethers, those preferred are selected from the group consisting of polyethylene glycols, polypropylene glycols, polybutylene glycols, their copolymers and their blends with molecular weights from 2000 to 100000, preferably 5000 to 50000.

The composition according to the invention is extremely suitable for use in numerous practical applications for making products such as films, preferably blown films, also multilayer films.

The composition according to the invention is suitable for making packaging of various kinds, in particular bags for transporting goods and bags for food packaging such as bags for food and vegetables.

The composition according to the invention may be advantageously used in cast extrusion processes.

The film made with the composition according to the present invention advantageously has a thickness of between 12 and 50 μm, preferably 40 μm or less, more preferably 30 μm or less.

The monolayer film has optical Haze properties of less than 20%, preferably less than 15% and clarity greater than 90%, preferably greater than 95%, measured according to ASTM D1003 standard on a 30 μm thick film.

The multilayer film which is a further object of the present invention comprises at least one layer A, one layer B and/or one layer C, preferably characterised by an arrangement selected from A/B, A/C/B and A/C/A.

The multilayer film has advantageously optical Haze properties of less than 35%, preferably less than 25% and clarity greater than 70%, preferably greater than 90%, measured according to ASTM standard D1003 on a 40-micron thick film.

As far as mechanical properties are concerned, within the meaning of the present invention they are determined according to ASTM D882 (tensile strength at 23° C. and 55% relative humidity and vo=50 mm/min) in the longitudinal direction with respect to the film-forming direction. The film, whether monolayer or multilayer, is characterised by a Young's modulus of above 600 MPa, preferably above 800 MPa, even more preferably above 1100 MPa and lower than 4000 MPa, preferably lower than 3500 MPa, even more preferably lower than 3200 MPa.

Both monolayer and multilayer films obtained according to the present invention advantageously exhibit WVTR (Water Vapour Transmission Rate) values of less than 200 g/m²/day, preferably less than 150 g/m²/day, measured according to ASTM F1249 at 23° C. 85% RH, on a 30 μm thick film.

The multilayer film according to the present invention has the following structure and composition:

### Layer A

Layer A consists of the components i.-v. described above.

### Layer B

As for layer B, this comprises at least one aliphatic polyester and one aliphatic-aromatic polyester:
vi) 40-70% by weight, preferably 55-65% by weight, of at least one aliphatic-aromatic polyester comprising, by weight, the sum of components vi.-ix.:
   e) a dicarboxylic component comprising, compared to the total dicarboxylic component:
      e1) 42-60% in moles, preferably 45-49.5% in moles, of units derived from at least one aromatic dicarboxylic acid;
      e2) 58-40% in moles, preferably 55-50.5% in moles, of units derived from at least one saturated aliphatic dicarboxylic acid.
   f) a diol component comprising, compared to the total diol component:
      f1) 95-100% in moles of units derived from at least one saturated aliphatic diol;
      f2) 0-5% in moles of units derived from at least one unsaturated aliphatic diol.
vii) 30-60% by weight, preferably 35-45% by weight, of at least one aliphatic polyester comprising, by weight, the sum of components vi.-ix.:
   g) a saturated dicarboxylic component
      g1) 55-85% in moles of units derived from succinic acid;
      g2) 15-45% in moles of units derived from at least one saturated dicarboxylic acid with a number of carbon atoms greater than 4;
   h) a diol component comprising, compared to the total diol component:
      h1) 95-100% in moles of units derived from 1,4-butanediol;
      h2) 0-5% in moles of units derived from at least one saturated aliphatic diol other than 1,4-butanediol.
viii) 0-20% by weight of at least one polyhydroxyalkanoate;
ix) 0-2.5% by weight, more preferably 0.02-1.5% by weight, even more preferably 0.1-1.0% by weight, with respect to the sum of components vi.-ix., of at least one crosslinking agent and/or chain extender comprising at least one di- and/or polyfunctional compound bearing groups selected from isocyanate, peroxide, carbodiimide, isocyanurate, oxazoline, epoxide, anhydride, divinyl ether and mixtures thereof.

As far as aliphatic-aromatic polyesters vi. are concerned, they are defined as the aliphatic-aromatic polyesters ii.

As regards the aliphatic polyesters vii., these are present between 30-60% by weight, preferably 35-45% by weight, with respect to the total vi.-ix. polymer composition. Said aliphatic polyesters vii. comprise a dicarboxylic component comprising, with respect to the total dicarboxylic component, 55-85% by weight, preferably 60-75% by weight, of units derived from succinic acid (component g1), and 15-45% by weight, preferably 25-40% by weight, of units derived from at least one saturated dicarboxylic acid having a number of carbon atoms greater than 4 (component g2).

Preferably, the saturated aliphatic dicarboxylic acids other than succinic acid of aliphatic polyester vii. are preferably selected from C₅-C₁₃, preferably C₅-C₁, saturated dicarboxylic acids, their C₁-C₂₄, preferably C₁-C₄, alkyl esters, their salts and mixtures thereof. Preferably, the saturated aliphatic dicarboxylic acids other than succinic acid are selected from the group consisting of: glutaric acid, 2-methylglutaric acid, adipic acid, pimelic acid, suberic acid, azelaic acid, sebacic acid, undecanedioic acid, dodecanedioic acid, brassylic acid and their C₁-C₂₄ alkyl esters. In a preferred embodiment of the present invention, the saturated aliphatic dicarboxylic acid other than succinic acid is selected from the group consisting of adipic acid, azelaic acid, sebacic acid or mixtures thereof. In an even more preferred embodiment of the present invention, the saturated aliphatic dicarboxylic acid other than succinic acid is azelaic acid.

The dicarboxylic component of aliphatic polyesters vii. may comprise up to 5% unsaturated aliphatic dicarboxylic acids, preferably selected from the group consisting of itaconic acid, fumaric acid, 4-methylene-pimelic acid, 3,4-bis(methylene) nonanedioic acid, 5-methylene-nonanedioic acid, their C₁-C₂₄, preferably C₁-C₄, alkyl esters, their salts and mixtures thereof.

In a preferred embodiment of the present invention, the unsaturated aliphatic dicarboxylic acids comprise mixtures comprising at least 50% in moles, preferably more than 60% in moles, more preferably more than 65% in moles, of itaconic acid or its C₁-C₂₄, preferably C₁-C₄ esters. More preferably, said unsaturated aliphatic dicarboxylic acids consist of itaconic acid.

The diol component of aliphatic polyesters vii. comprises, with respect to the total diol component, 95-100% in moles, preferably 97-100% in moles, of units derived from 1,4-butanediol (component h1), and 0-5% in moles, preferably 0-3% in moles, with respect to the total diol component, of units derived from at least one saturated aliphatic diol other than 1,4-butanediol (component h2).

The saturated aliphatic diols of aliphatic polyesters vii. are preferably selected from the group consisting of 1,2-ethanediol, 1,2-propanediol, 1,3-propanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,4-cyclohexanedimethanol neopentylglycol, 2-methyl-1,3-propanediol, dianhydrosorbitol, dianhydromannitol, dianhydroiditol, cyclohexanediol, cyclohexanmethanediol, dialkylene glycols and polyalkylene glycols with a molecular weight of 100-4000 such as polyethylene glycol, polypropylene glycol and mixtures thereof.

The diol component of aliphatic polyesters vii. may comprise up to 5% of unsaturated aliphatic diols, preferably selected from the group consisting of cis 2-butene-1,4-diol, trans 2-butene-1,4-diol, 2-butyne-1,4-diol, cis 2-pentene-1,5-diol, trans 2-pentene-1,5-diol, 2-pentyne-1,5-diol, cis 2-hexene-1,6-diol, trans 2-hexene-1,6-diol, 2-hexyne-1,6-diol, cis 3-hexene-1,6-diol, trans 3-hexene-1,6-diol, 3-hexene-1,6-diol.

In a particularly preferred embodiment, aliphatic polyesters vii. are selected from the group consisting of poly(1,4-butylene succinate-co-adipate), poly(1,4-butylene succinate-co-1,4-butylene azelate), poly(1,4-butylene succinate-co-1,4-butylene sebacate). In an even more preferred embodiment, aliphatic polyester vii. is poly(1,4-butylene succinate-co-1,4-butylene azelate).

In the process of preparation of aliphatic polyesters vii., one or more polyfunctional molecules may also advantageously be added in quantities of between 0.1 and 3 moles to the total moles of the dicarboxylic component (as well as any hydroxy acids) in order to obtain branched products. Examples of these molecules are glycerol, pentacrythritol, trimethylolpropane, citric acid, dipentaerythritol, monoanhydrosorbitol, monohydromannitol, acid triglycerides, polyglycerols, etc.

The molecular weight Mn of aliphatic polyesters vii. is preferably ≥20000, more preferably ≥40000. As for the polydispersity index of the molecular weights Mw/Mn, this is preferably between 1.5 and 10, more preferably between 1.6 and 5 and even more preferably between 1.8 and 3.5.

Molecular weights Mₙ and M_{w} may be measured by Gel Permeation Chromatography (GPC). The determination may be conducted with the chromatographic system maintained at 40° C., using a set of two columns in series (particle diameter 5 μm and 3 μm with mixed porosity), a refractive index detector, chloroform as eluent (flow rate 0.5 ml/min) and using polystyrene as reference standard.

The Melt Flow Rate (MFR) of aliphatic polyesters vii. is preferably between 500 and 1 g/10 min, more preferably between 100 and 3 g/10 min, even more preferably between 15 and 4 g/10 min (measurement carried out at 190° C./2.16 kg according to ISO 1133-1 “Plastics—determination of the melt mass-flow rate (MFR) and melt volume flow rate (MVR) of thermoplastics—Part 1: Standard method”).

The terminal acid group content of aliphatic polyesters vii. is preferably between 15 and 160 meq/kg, more preferably between 30 and 100 meq/kg and even more preferably between 40 and 60 meq/kg.

The terminal acid groups content may be measured as follows: 1.5-3 g of the polyester is placed in a 100 ml conical flask together with 60 ml of chloroform. After complete dissolution of the polyester, 25 ml 2-propanol is added and, immediately before analysis, 1 ml deionised water is added. The resulting solution is titrated with a previously standardised solution of NaOH in ethanol. An appropriate indicator, such as a glass electrode for acid-base titrations in non-aqueous solvents, is used to determine the equivalence point of the titration. The terminal acid groups content is calculated on the basis of the consumption of NaOH solution in ethanol according to the following equation:

$$Terminal acid groups content ( meq / kg polymer ) = \frac{⌊ ( {V}_{e q} - {V}_{b} ) \cdot T ⌋ \cdot 1000}{P}$$

where: V_{eq}=ml of NaOH solution in ethanol at the equivalence point of the sample titration;
   V_{b}=ml of NaOH solution in ethanol required to reach pH=9.5 during the blank titration;
   T=concentration of NaOH solution in ethanol expressed in moles/litre;
   P=weight of sample in grams.

Preferably, aliphatic polyesters vii. have an inherent viscosity (measured with an Ubbelohde viscometer for solutions in CHCl₃ of concentration 0.2 g/dl at 25° C.) greater than 0.3 dl/g, preferably between 0.3 and 2 dl/g, more preferably between 0.4 and 1.3 dl/g.

Polyhydroxyalkanoate viii. is preferably selected from the group consisting of lactic acid polyesters, polyhydroxy butyrate, polyhydroxy butyrate-valerate, polyhydroxy butyrate-propanoate, polyhydroxy butyrate-hexanoate polyhydroxy butyrate-decanoate, polyhydroxy butyrate, polyhydroxy butyrate, polyhydroxy butyrate, poly 3-hydroxybutyrate-4-hydroxybutyrate and mixtures thereof. Said polyhydroxyalkanoate viii. is present from 0 to 20% by weight of the sum of the components vi.-ix.

In a preferred embodiment, said lactic acid polyesters are selected from the group consisting of poly L-lactic acid, poly D-lactic acid, poly D-L lactic acid stereo complex, copolymers comprising more than 50% in moles of said lactic acid polyesters or mixtures thereof.

Particularly preferred are lactic acid polyesters containing at least 95% by weight of repetitive units derived from L-lactic or D-lactic acid or combinations thereof, with a molecular weight Mw greater than 50000 and a shear viscosity of 50-700 Pa·s, preferably between 80 and 500 Pa·s (measured according to ASTM D3835 standard at T=190° C., shear rate=1000 s⁻¹, D=1 mm, L/D=10).

In a particularly preferred embodiment, the lactic acid polyester comprises at least 95% by weight of units derived from L-lactic acid, ≤5% by weight of repetitive units derived from D-lactic acid, has a melting temperature in the range 135-175° C., a glass transition temperature (Tg) in the range 55-65° C. and an MFR (measured according to ISO standard 1133-1 at 190° C. and 2.16 kg) in the range 1-50 g/10 min. Commercial examples of lactic acid polyesters with these properties are, for example, Ingeo™ Biopolymer 4043D and 3251D.

With regard to the cross-linking agent and/or chain extender ix., this component is defined as component v.

### Layer C

As for layer C, this comprises at least one polyester, which may be an aliphatic polyester (component x.) or an aliphatic-aromatic polyester (component xi.) or a mixture thereof.

As for aliphatic polyesters x., these preferably comprise a dicarboxylic component comprising, with respect to the total dicarboxylic component, 60-100% in moles, preferably 90-95% in moles, of units derived from succinic acid, and 0-40% in moles, preferably 5-10% in moles, of units derived from at least one saturated dicarboxylic acid other than succinic acid.

Preferably, the saturated aliphatic dicarboxylic acids other than succinic acid of the aliphatic polyester x. of the composition according to the present invention are preferably selected from saturated C₅-C₁₃, preferably C₅-C₁₁ dicarboxylic acids, C₁-C₂₄, preferably C₁-C₄ alkyl esters thereof, their salts and mixtures thereof. Preferably, the saturated aliphatic dicarboxylic acids other than succinic acid are selected from: glutaric acid, 2-methylglutaric acid, adipic acid, pimelic acid, suberic acid, azelaic acid, sebacic acid, undecanedioic acid, dodecanedioic acid, brassylic acid and their C₁-C₂₄ alkyl esters. In a preferred embodiment, the saturated aliphatic dicarboxylic acid other than succinic acid is selected from the group consisting of adipic acid, azelaic acid, sebacic acid or mixtures thereof. In an even more preferred embodiment, the saturated aliphatic dicarboxylic acid other than succinic acid is azelaic acid.

As far as aliphatic-aromatic polyesters xi. are concerned, preferably they can be defined as the aliphatic-aromatic polyesters ii.

Preferably layer C comprises an aliphatic polyester (component x.).

Ready compostability under home composting conditions means disintegration of more than 90% within 180 days according to UNI 11355 appendix A (test method).

Ready biodegradability in the marine environment means biodegradation of more than 60% within 400 days measured according to ISO 19679.

What is particularly surprising is that marine biodegradation takes place with high polylactic percentages, whereas PLA is known to hinder biodegradation under these conditions.

The multilayer film permits good weldability to be achieved even at low temperatures. Good weldability is defined as a weld strength of over 12 N measured according to ASTM F88 (technique A, 300 mm/min, specimen width 25.4 mm) in a weld between the B-layers (inside/inside contact) made at 85° C. with 15 cm² Teflon-coated welding rods, for a welding time of 1 sec and high holding strength of 350 N.

The composition according to the present invention also finds application for the manufacture of other types of articles such as fibres, nonwoven fabrics, foils, moulded, thermoformed, blown, foamed and laminated articles, also using the extrusion coating technique.

The present invention also relates to articles comprising the composition according to the present invention.

Examples of products comprising the composition according to the present invention are:
films, both mono- and bi-oriented, and multi-layer films with other polymer materials;
fabrics for use in the agricultural sector as agro-textile cloth;
thermoformed food packaging in both single and multilayer forms such as containers for milk, yoghurt, meat, beverages, etc;
coatings obtained using the extrusion coating technique;
multilayer laminates with layers of paper, plastics, aluminium, metallised films;
containers in general for fruit and vegetables;
fibres, microfibres, composite fibres with a core made of rigid polymers such as PLA, PET, PTT, etc., and an outer shell of the material according to the invention, dablens composite fibres, fibres with different cross-sections, from round to multilobed, staple fibres, woven and non-woven or spunbonded or thermobonded fabrics for the health, hygiene, agriculture and clothing sectors.

The invention will now be illustrated with some examples of embodiments, which are intended to be illustrative and not limiting the scope of protection of this patent application.

### EXAMPLES

### Component i.

i=Poly(1,4-butylene succinate-co-1,4-butylene azelaic acid) (“PBSAz-1”) prepared according to the following method: 14830 g of succinic acid, 2625 g of azelaic acid, 2650 g of 1,4-butanediol, 25.7 g of glycerine and 2.0 g of an 80% by weight ethanolic solution of diisopropyl triethanolamino titanate (Tyzor TE, containing 8.2% by weight titanium) were charged in a molar diol/dicarboxylic acid (MGR) ratio of 1.07 into a steel reactor with a geometric capacity of 60 litres, equipped with a mechanical stirring system, a nitrogen inlet, a distillation column, a high-boiling distillate removal system and a connection to a high vacuum system. The temperature of the mass was gradually raised to 230° C. over 120 minutes. When 95% of the theoretical water had been distilled off, 21.25 g of tetra n-butyl titanate was added (corresponding to 119 ppm metal compared to the amount of poly(1,4-butylene succinate-co-1,4-butylene azelate) theoretically obtainable by converting all the succinic acid and azelaic acid fed to the reactor). The reactor temperature was then raised to 235-240° C. and the pressure was gradually reduced to below 2 mbar over 60 minutes. The reaction was allowed to proceed for the time necessary to obtain a poly(1,4-butylene succinate-co-1,4-butylene azelate) with an MFR of about 7 (g/10 minutes at 190° C. and 2.16 kg), and the material then was discharged as strands into a water bath and granulated.

### Component ii.

ii=Poly(1,4-butylene adipate-co-1,4-butylene terephthalate) (“PBAT”) prepared according to the following method: 7453 g of terephthalic acid, 7388 g of adipic acid, 12033 g of 1,4-butanediol, 4.4 g of glycerol and 3.4 g of an 80% by weight ethanolic solution of diisopropyl triethanolamino titanate (Tyzor TE, containing 8.2 wt. % titanium) were charged in a molar ratio of diol to dicarboxylic acid (MGR) of 1.40 into a steel reactor with a geometric capacity of 60 litres, equipped with a mechanical stirring system, a nitrogen inlet, a distillation column, a high-boiling distillate removal system and a connection to a high vacuum system. The temperature of the mass was gradually raised to 230° C. over 120 minutes. When 95% of the theoretical water had been distilled off, 17.0 g of tetra n-butyl titanate was added (corresponding to 119 ppm metal compared to the amount of poly(1,4-butylene adipate-co-1,4-butylene terephthalate) theoretically obtainable by converting all the adipic acid and terephthalic acid fed to the reactor). The reactor temperature was then raised to 235-240° C. and the pressure was gradually reduced to below 2 mbar over 60 minutes. The reaction was allowed to proceed for the time necessary to obtain a poly(1,4-butylene adipate-co-1,4-butylene terephthalate) with an MFR of about 6 (g/10 minutes at 190° C. and 2.16 kg), and the material was then discharged as strands into a water bath and granulated.

### Component iii.

iii-1=polylactic acid (‘PLA’) Ingeo 3251D, MFR 36/10 min (@ 190° C., 2.16 Kg) and shear viscosity 145 Pa·s (ASTM D3835 at T=190° C., shear rate=1000 s⁻¹, D=1 mm, L/D=10).
iii-2=polylactic acid (‘PLA’) Ingeo 4043D, MFR 3/10 min (@ 190° C., 2.16 Kg) and shear viscosity 360 Pa·s (ASTM D3835 at T=190° C., shear rate=1000 s⁻¹, D=1 mm, L/D=10).

### Component vi.

vi=Component ii.

### Component vii.

vii=Poly(1,4-butylene succinate-co-1,4-butylene azelaic acid) (“PBSAz-2”) prepared according to the following method: 9760 g of succinic acid, 8370 g of azelaic acid, 12250 g of 1,4-butanediol, 23.4 g of glycerine and 2.0 g of an 80% by weight ethanolic solution of diisopropyl triethanolamino titanate (Tyzor TE, containing 8.2% by weight titanium) were charged in a molar diol/dicarboxylic acid (MGR) ratio of 1.07 into a steel reactor with a geometric capacity of 60 litres, equipped with a mechanical stirring system, a nitrogen inlet, a distillation column, a high-boiling distillate removal system and a connection to a high vacuum system. The temperature of the mass was gradually raised to 230° C. over 120 minutes. When 95% of the theoretical water had been distilled off, 21.25 g of tetra n-butyl titanate was added (corresponding to 119 ppm metal compared to the amount of poly(1,4-butylene succinate-co-1,4-butylene azelate) theoretically obtainable by converting all the succinic acid and azelaic acid fed to the reactor). The reactor temperature was then raised to 235-240° C. and the pressure was gradually reduced to below 2 mbar over 60 minutes. The reaction was allowed to proceed for the time necessary to obtain a poly(1,4-butylene succinate-co-1,4-butylene azelate) with an MFR of about 7.6 (g/10 minutes at 190° C. and 2.16 kg), and the material then was discharged as strands into a water bath and granulated.

### Component x.

x=component i.

### Component xi.

xi=component ii.

### Masterbatch

m−1=masterbatch comprising 15% by weight of silica (component iv.) and 85% by weight of component ii.
m−2=masterbatch comprising 10% by weight of Joncryl ADR4368CS (component v.) and 90% by weight of component iii-1.
m−3=masterbatch comprising 10% by weight of Joncryl ADR4368CS (component ix.) and 90% by weight of polylactic acid Ingeo 3251D (component viii.).

The compositions shown in Table 1 were fed to a co-rotating twin-screw extruder model OMC EBV60/36 (L/D=36; diameter 58 mm), operating under the following conditions:
rpm: 140
flow rate: 40 kg/h
thermal profile: 60-150-180-210×4-150×2° C.
vacuum degassing in zone 4

The resulting compound granules of Examples 1-4 and Comparison examples 1-5 were fed at a flow rate of 26 kg/h to a Ghioldi model blown film machine with a 40 mm diameter screw and L/D 30 operating at 64 rpm with a 120-170-210×7° C. thermal profile. The film-forming head with an air gap of 0.9 mm and L/D 12 was set at 180° C. Film-forming was carried out with a blowing ratio of 3.2 and a stretching ratio of 14.5. This resulted in a film thickness of 30 μm. The optical properties were determined according to ASTM standard D1003. See Table 2 The mechanical properties were determined according to ASTM D882 (tensile strength at 23° C. and 55% relative humidity and vo=50 mm/min). See Table 3.

TABLE 1
Compositions of the examples

| | Components (%) | | | | | |
|---|---|---|---|---|---|---|
| Examples | I | Ii | iii-1 | iii-2 | m-1 | m-2 |
| Example 1 | 36.0 | — | 61.5 | — | — | 2.5 |
| Example 2 | 24.5 | — | 73.0 | — | — | 2.5 |
| Example 3 | 14.5 | — | 83.0 | — | — | 2.5 |
| Example 4 | 35.5 | — | 61.0 | — | 1 | 2.5 |
| Comparison 1 | 73.0 | — | 24.5 | — | — | 2.5 |
| Comparison 2 | — | — | 100 | — | — | — |
| Comparison 3 | 35.7 | — | — | 63.0 | — | 1.3 |
| Comparison 4 | 18.0 | 18 | 61.5 | — | — | 2.5 |
| Comparison 5 | 100 | — | — | — | — | — |

### Example 5—Two-Layer Film with Arrangement A/B

Preparation of Example 6 (layer B): a composition comprising 58.5% of component vi., 39% of component vii. and 2.5% of masterbatch m−3 was fed to a co-rotating twin-screw extruder model OMC EBV60/36 (L/D=36; diameter 58 mm), operating in the same conditions as Examples 1-4.

The compound granules of Example 1 (Table 1) and of Example 6 were fed simultaneously to a co-extruder to form a two-layer blown film having an A/B arrangement. For this purpose, the compound granules of Example 1 (layer A) were fed through two extruders, the first characterized by a screw diameter of 40 mm with an L/D of 30 operating at 35 rpm with a thermal profile of 60-170-200×3 at a flow rate of 18.0 kg/h and a second extruder characterised by a screw diameter of 35 mm with an L/D of 30 operating at 24 rpm with a thermal profile of 60-170-200×3 at a flow rate of 6.0 kg/h.

In parallel the compound granules of Example 6 (layer B) were fed at 6.0 kg/h to an extruder with a 35 mm screw diameter with an L/D of 30 operating at 30 rpm with a thermal profile 60-135-145×3. The compositions, once melted, were coupled in a coextrusion-blowing head with an air gap of 0.9 mm and L/D 9 set at 200° C., feeding the multilayer structure to a film-forming process operating with a blowing ratio of 3.2 and a stretch ratio of 7.

The resulting film (total 40-micron, 80% layer A, 20% layer B) was then characterised in terms of optical properties (Table 2), mechanical properties (Table 3) and disintegration properties (Table 5).

### Example 7—Three-Layer Film with Arrangement A/C/B

The compound granules of Example 1 (Table 1, layer A), component xi. (Layer C) and the compound granules of Example 6 (layer B) were fed simultaneously to a co-extruder to form a three-layer blown film having an A/C/B arrangement.

For this purpose, compound granules of Example 1 were fed at a flow rate of 15.0 kg/h to a first extruder having a screw diameter of 35 mm with an L/D of 30 operating at 63 rpm with a thermal profile of 60-170-200×3, component xi. was fed at a flow rate of 9.0 kg/h flow rate to a second extruder characterised by a screw diameter of 40 mm with an L/D of 30 operating at 32 rpm with a thermal profile of 60-135-160×3 and compound granules of Example 6 were fed at 6.0 kg/h to an extruder with a 35 mm screw diameter with an L/D of 30 operating at 25 rpm with a thermal profile 60-135-145×3.

The compositions, once melted, were coupled in a coextrusion-blowing head with an air gap of 0.9 mm and L/D 9 set at 200° C., feeding the multilayer structure to a film-forming process operating with a blowing ratio of 3.2 and a stretch ratio of 7.

The resulting film (total 40-micron, 50% layer A, 30% layer C, 20% layer B) was then characterised in terms of optical properties (Table 2), mechanical properties (Table 3) and disintegration properties (Table 5).

### Example 8—Three-Layer Film with Arrangement A/C/B

The compound granules of Example 1 (Table 1, layer A), component x. (layer C) and the compound granules of Example 6 (layer B) were fed simultaneously to a co-extruder to form a three-layer blown film having an A/C/B arrangement. For this purpose, compound granules of Example 1 were fed at a flow rate of 15.0 kg/h to a first extruder having a screw diameter of 35 mm with an L/D of 30 operating at 58 rpm with a thermal profile of 60-170-200×3, component x. was fed at a flow rate of 9.0 kg/h flow rate to a second extruder characterised by a screw diameter of 40 mm with an L/D of 30 operating at 26 rpm with a thermal profile of 60-135-160×3 and compound granules of Example 6 were fed at 6.0 kg/h to an extruder with a 35 mm screw diameter with an L/D of 30 operating at 25 rpm with a thermal profile 60-135-145×3. The compositions, once melted, were coupled in a coextrusion-blowing head with an air gap of 0.9 mm and L/D 9 set at 200° C., feeding the multilayer structure to a film-forming process operating with a blowing ratio of 3.2 and a stretch ratio of 7.

The resulting film (total 40-micron, 50% layer A, 30% layer C, 20% layer B) was then characterised in terms of optical properties (Table 2), mechanical properties (Table 3) and disintegration properties (Table 5).

### Example 9—Three-Layer Film with Arrangement A/C/A

The compound granules of Example 1 (Table 1, layer A) and component x. (layer C) were fed simultaneously to a co-extruder to form a three-layer blown film having an A/C/A arrangement. For this purpose, compound granules of Example 1 were fed through two extruders, the first characterized by a screw diameter of 35 mm with an L/D of 30 operating at 42 rpm with a thermal profile of 60-170-200×3 at a flow rate of 10.6 kg/h and a second extruder characterised by a screw diameter of 35 mm with an L/D of 30 operating at 40 rpm with a thermal profile of 60-170-200×3 at a flow rate of 10.9 kg/h. In parallel component x. was fed at 8.8 kg/h to an extruder with a 40 mm screw diameter with an L/D of 30 operating at 24 rpm with a thermal profile 60-135-170×3. The compositions, once melted, were coupled in a coextrusion-blowing head with an air gap of 0.9 mm and L/D 9 set at 200° C., feeding the multilayer structure to a film-forming process operating with a blowing ratio of 3.2 and a stretch ratio of 7.

The resulting film (total 40-micron, 35% layer A, 30% layer C, 35% layer A) was then characterised in terms of optical properties (Table 2), mechanical properties (Table 3) and disintegration properties (Table 5).

TABLE 2
Optical Properties

| Examples | Haze [%]. | Clarity [%] |
|---|---|---|
| Example 1 | 9 | 97 |
| Example 2 | 7 | 97 |
| Example 3 | 9 | 97 |
| Example 4 | 10 | 91 |
| Example 5 | 12 | 97 |
| Example 7 | 26 | 90 |
| Example 8 | 21 | 97 |
| Example 9 | 17 | 99 |
| Comparison 1 | 34 | 58 |
| Comparison 2 | 32 | 58 |
| Comparison 3 | 32 | 47 |
| Comparison 4 | 21 | 96 |
| Comparison 5 | 33 | 98 |

TABLE 3
Mechanical properties were determined according to ASTM
D882 (Tensile strength at 23° C. and 55% relative
humidity and vo = 50 mm/min)

| | Ultimate tensile | Yield | Young's |
|---|---|---|---|
| | strength | strength | modulus |
| | σ_{b} | σ_{y} | E |
| Examples | (MPa) | (MPa) | (MPa) |
| Example 1 | 37 | 51 | 2440 |
| Example 2 | 42 | 55 | 2760 |
| Example 3 | 49 | 65 | 3010 |
| Example 5 | 31 | 42 | 1920 |
| Example 7 | 24 | 25 | 1170 |
| Example 8 | 24 | 21 | 1010 |
| Example 9 | 28 | 34 | 1650 |
| Comparison 1 | 29 | 24 | 1070 |
| Comparison 5 | 45 | 13 | 260 |

TABLE 4
Marine degradation according to ISO 19679
The marine biodegradation tests were performed according to standard
ISO19679: 2020 “Determination of aerobic biodegradation of non-floating
plastics at a seawater/sediment interface - Method by evolved carbon
dioxide analysis”. A film cut into discs weighing approximately
20 mg was placed on a marine sediment taken from the so-called
sub-littoral zone, i.e. at approximately 0.5/1 m below the water, all
immersed in synthetic seawater and incubated at a constant temperature of
28° C. The CO₂ produced was absorbed with KOH and
titrated with HCl.

| | Absolute | |
|---|---|---|
| Examples | biodegradation (%) | Days |
| Example 1 | 76 | 420 |
| Comparison 2 | 10 | 420 |

TABLE 5
Film disintegration process
Disintegration under home composting conditions was conducted
according to UNI standard 11355 App. A.
The degree of disintegration of the films comprising the composition
according to the present invention was determined by inserting
samples of dimensions 5 × 5 cm into the slides. The slides were placed
on top of a first layer of compost of about 4 cm and then covered
with a second compost layer of about 2 cm. The slides were periodically
observed and photographed to check their degree of disintegration.
A degree of disintegration was assigned according to an empirical scale:

| | |
|---|---|
| Degree of disintegration dd = 0 | Unchanged film |
| Degree of disintegration dd = 1 | Film with very few (1-2) holes - |
| | cuts etc. |
| Degree of disintegration dd = 2 | Film with scattered cuts, but structure |
| | still intact |
| Degree of disintegration dd = 3 | Film with degraded areas and diffuse |
| | breaks, loss of structure |
| Degree of disintegration dd = 4 | Film with very little residue, that |
| | can be recovered with difficulty |
| Degree of disintegration dd = 5 | Film completely disintegrated, no |
| | longer visible |

| | Degree of | |
|---|---|---|
| Examples | disintegration (dd) | Days |
| Example 1 | 5 | 180 |
| Example 5 | 5 | 135 |
| Example 7 | 5 | 121 |
| Example 8 | 5 | 121 |
| Example 9 | 5 | 149 |

1. A multilayer film comprising at least one layer A, one layer B and/or one layer C, in which the layer A is constituted by a polymeric composition comprising, with respect to the total of the composition:
i) 10-49% by weight with respect to the total of components i.-v., of at least one aliphatic polyester i. comprising:
a) a dicarboxylic component comprising, with respect to the total of the dicarboxylic component:
a1) 60-95% in moles of units derived from succinic acid;
a2) 5-40% in moles of units derived from at least a saturated dicarboxylic acid with a number of carbon atoms higher than 4;
b) a diol component comprising with respect to the total diol component:
b1) 95-100% in moles of units derived from 1,4-butanediol, and;
b2) 0-5% in moles of units derived from at least one saturated aliphatic diol other than 1,4-butanediol.
ii) 0-15% by weight with respect to the sum of components i.-v., of at least one aliphatic-aromatic polyester ii. comprising:
c) a dicarboxylic component comprising with respect to the total of the dicarboxylic component:
c1) 42-60% in moles of units derived from at least one aromatic dicarboxylic acid;
c2) 58-40% in moles of units derived from at least one saturated aliphatic dicarboxylic acid.
d) a diol component comprising with respect to the total diol component
d1) 95-100% in moles of units derived from at least one saturated aliphatic diol;
d2) 0-5% in moles of units derived from at least one unsaturated aliphatic diol.
iii) 51-90% by weight with respect to the sum of components i.-v. of at least one or more polyesters of lactic acid;
iv) 0-1.5% by weight with respect to the sum of components i.-v. of at least one inorganic filler.
v) 0-2.5% by weight with respect to the sum of component i.-v., of at least one crosslinking agent and/or chain extender, comprising at least one compound having two and/or multiple functional groups including groups selected from isocyanate, peroxide, carbodiimide, isocyanurate, oxazoline, epoxide, anhydride, divinylether, and mixtures thereof;
the layer B comprises at least one aliphatic polyester and one aliphatic-aromatic polyester comprising:
vi) 40-70% by weight with respect to the sum of components vi.-ix., of at least one aliphatic-aromatic polyester comprising:
e) a dicarboxylic component comprising, with respect to the total of the dicarboxylic component:
e1) 42-60% in moles of units derived from an aromatic dicarboxylic;
e2) 40-58% in moles, of units derived from at least one saturated aliphatic dicarboxylic acid;
e3) 0-5% in moles, of units derived from at least one unsaturated aliphatic dicarboxylic acid;
f) a diol component comprising with respect to the total diol component
f1) 95-100% in moles of units derived from at least one saturated aliphatic diol;
f2) 0-5% in moles of units derived from at least one unsaturated aliphatic diol;
vii) 30-60% by weight with respect to the sum of components vi.-ix., of at least one aliphatic polyester comprising:
g) a dicarboxylic saturated component comprising,
g1) 55-85% in moles of units derived from succinic acid;
g2) 15-45% in moles of units derived from a dicarboxylic saturated acid with a number of carbon atoms higher than 4;
h) a diol component comprising with respect to the total diol component:
h1) 95-100% in moles of units derived from 1,4-butanediol;
h2) 0-5% in moles of units derived from at least a saturated aliphatic diol different from 1,4-butanediol.
viii) 0-20% by weight, with respect to the sum of components vi.-ix., of at least a polyhydroxyalcanoate;
ix) 0-2.5% by weight with respect to the sum of components vi.-ix., of at least one crosslinking agent and/or chain extender comprising at least one di- and/or polyfunctional compound bearing groups selected from isocyanate, peroxide, carbodiimide, isocyanurate, oxazoline, epoxide, anhydride, divinyl ether and mixtures thereof.
and the layer C comprises at least a polyester which may be an aliphatic polyester (component x.) or an aliphatic-aromatic polyester (component xi.) or a mixture thereof.

2. The multilayer film according to claim 1 in which the saturated aliphatic dicarboxylic acid of layer A (component a2) with a number of carbon atoms higher than 4 is selected from the group consisting of adipic acid, azelaic acid, sebacic acid, and mixtures thereof.

3. The multilayer film according to claim 2 in which the saturated aliphatic dicarboxylic acid with a number of carbon atoms higher than 4 is azelaic acid.

4. The multilayer film according to claim 1 in which the aliphatic polyesters i. are selected in the group consisting of poly(1,4-butylene succinate-co-1,4-butylene-adipate), poly(1,4-butylene succinate-co1,4-butylene-azelate), poly(1,4-butilene succinate-co-1,4-butylene sebacate).

5. The multilayer film according to claim 1 in which the aliphatic-aromatic polyester (component ii.) is selected in the group constituted by: poly(1,4 butylene adipate-co-1,4-butylene terephthalate, poly(1,4-butylene sebacate-co-1,4-butylene terephthalate), poly(1,4-butylene azelate-co-1,4-butylene terephthalate), poly(1,4-butylene brassylate-co-1,4-butylene terephthalate), poly(1,4-butylene succinate-co-1,4-butylene terephthalate), poly(1,4-butylene adipate-co-1,4-butylene sebacate-co-1,4-butylene terephthalate), poly(1,4-butylene azelate-co-1,4-butylene sebacate-co-1,4-butylene terephthalate), poly(1,4-butyleneadipate-co-1,4-butylene-azelate-co-1,4-butylene-terephthalate), poly(1,4-butylenesuccinate-co-1,4-butylenesebacate-co-1,4-butylene terephthalate), poly(1,4-butyleneadipate-co-1,4-butylene succinate-co-1,4-butylene terephthalate), poly(1,4-butyleneazelate-co-1,4-butylene succinate-co-1,4-butylene terephthalate).

6. The multilayer film according to claim 1 in which the lactic acid polyester (component iii.) contains at least 95% by weight of repetitive units derived from L-lactic or D-lactic acid or combinations thereof, with a molecular weight Mw of more than 50000 and shear viscosity comprised between 50÷250 Pa*s (measured according to ASTM standard D3835 at T=190° C., shear rate=1000 s·1, D=1 mm, L/D=10).

7. The multilayer film according to claim 1, in which the lactic acid polyester comprises at least 96% by weight of units deriving from L-lactic acid, ≤4% of units deriving D-lactic acid and has a melting point in the range 160-180° C., a glass transition temperature (Tg) in the range 55-65° C. and a MFR (measured according to ASTM-D1238 standard at 190° C. and 2.16 kg on dried polymer (water content lower than 400 ppm) in the range 10-50 g/10 min.

8. The multilayer film according to claim 1, in which the inorganic filler (component iv.) is selected in the group constituted by kaolin, barytes, clay, talc, calcium and magnesium, iron and lead carbonates, aluminium hydroxide, diatomaceous earth, aluminium sulphate, barium sulphate, silica, mica, titanium dioxide, and wollastonite

9. The multilayer film according to claim 1, in which the inorganic filler (component iv.) is selected from mica, calcium carbonate, silica and their mixtures, present in the form of particles having an average arithmetic diameter lower than 10 μm, measured with respect to the main axis of the particles (measured according to ASTM 13320).

10. The multilayer film according to claim 1 in which the crosslinking agent and/or chain extender (component v.) is selected from two and/or multiple functional groups selected from isocyanate, peroxide, carbodiimide, isocyanurate, oxazoline, epoxide, anhydride, divinylether, and mixtures thereof.

11. The multilayer film according to claim 1 in which the aliphatic polyesters vi. of layer B are selected in the group consisting of poly(1,4-butylene succinate-co-1,4-butylene-adipate), poly(1,4-butylene succinate-co1,4-butylene-azelate), poly(1,4-butilene succinate-co-1,4-butylene sebacate).

12. The multilayer film according to claim 1 in which the aliphatic-aromatic polyester (component vi.) of layer B is selected in the group constituted by: poly(1,4 butylene adipate-co-1,4-butylene terephthalate, poly(1,4-butylene sebacate-co-1,4-butylene terephthalate), poly(1,4-butylene azelate-co-1,4-butylene terephthalate), poly(1,4-butylene brassylate-co-1,4-butylene terephthalate), poly(1,4-butylene succinate-co-1,4-butylene terephthalate), poly(1,4-butylene adipate-co-1,4-butylene sebacate-co-1,4-butylene terephthalate), poly(1,4-butylene azelate-co-1,4-butylene sebacate-co-1,4-butylene terephthalate), poly(1,4-butyleneadipate-co-1,4-butylene-azelate-co-1,4-butylene-terephthalate), poly(1,4-butylenesuccinate-co-1,4-butylenesebacate-co-1,4-butylene terephthalate), poly(1,4-butyleneadipate-co-1,4-butylene succinate-co-1,4-butylene terephthalate), poly(1,4-butyleneazelate-co-1,4-butylene succinate-co-1,4-butylene terephthalate).

13. The multilayer film according to claim 1, characterized by a disintegrability according to UNI 11355 Annex A (test method) higher than 90% within 180 days and a biodegradability in marine environment higher than 60% within 400 days measured according to ISO 19679.

14. The multilayer film according to claim 2 in which the aliphatic polyesters i. are selected in the group consisting of poly(1,4-butylene succinate-co-1,4-butylene-adipate), poly(1,4-butylene succinate-co1,4-butylene-azelate), poly(1,4-butilene succinate-co-1,4-butylene sebacate).

15. The multilayer film according to claim 3 in which the aliphatic polyesters i. are selected in the group consisting of poly(1,4-butylene succinate-co-1,4-butylene-adipate), poly(1,4-butylene succinate-co1,4-butylene-azelate), poly(1,4-butilene succinate-co-1,4-butylene sebacate).

16. The multilayer film according to claim 2 in which the aliphatic-aromatic polyester (component ii.) is selected in the group constituted by: poly(1,4 butylene adipate-co-1,4-butylene terephthalate, poly(1,4-butylene sebacate-co-1,4-butylene terephthalate), poly(1,4-butylene azelate-co-1,4-butylene terephthalate), poly(1,4-butylene brassylate-co-1,4-butylene terephthalate), poly(1,4-butylene succinate-co-1,4-butylene terephthalate), poly(1,4-butylene adipate-co-1,4-butylene sebacate-co-1,4-butylene terephthalate), poly(1,4-butylene azelate-co-1,4-butylene sebacate-co-1,4-butylene terephthalate), poly(1,4-butyleneadipate-co-1,4-butylene-azelate-co-1,4-butylene-terephthalate), poly(1,4-butylenesuccinate-co-1,4-butylenesebacate-co-1,4-butylene terephthalate), poly(1,4-butyleneadipate-co-1,4-butylene succinate-co-1,4-butylene terephthalate), poly(1,4-butyleneazelate-co-1,4-butylene succinate-co-1,4-butylene terephthalate).

17. The multilayer film according to claim 3 in which the aliphatic-aromatic polyester (component ii.) is selected in the group constituted by: poly(1,4 butylene adipate-co-1,4-butylene terephthalate, poly(1,4-butylene sebacate-co-1,4-butylene terephthalate), poly(1,4-butylene azelate-co-1,4-butylene terephthalate), poly(1,4-butylene brassylate-co-1,4-butylene terephthalate), poly(1,4-butylene succinate-co-1,4-butylene terephthalate), poly(1,4-butylene adipate-co-1,4-butylene sebacate-co-1,4-butylene terephthalate), poly(1,4-butylene azelate-co-1,4-butylene sebacate-co-1,4-butylene terephthalate), poly(1,4-butyleneadipate-co-1,4-butylene-azelate-co-1,4-butylene-terephthalate), poly(1,4-butylenesuccinate-co-1,4-butylenesebacate-co-1,4-butylene terephthalate), poly(1,4-butyleneadipate-co-1,4-butylene succinate-co-1,4-butylene terephthalate), poly(1,4-butyleneazelate-co-1,4-butylene succinate-co-1,4-butylene terephthalate).

18. The multilayer film according to claim 4 in which the aliphatic-aromatic polyester (component ii.) is selected in the group constituted by: poly(1,4 butylene adipate-co-1,4-butylene terephthalate, poly(1,4-butylene sebacate-co-1,4-butylene terephthalate), poly(1,4-butylene azelate-co-1,4-butylene terephthalate), poly(1,4-butylene brassylate-co-1,4-butylene terephthalate), poly(1,4-butylene succinate-co-1,4-butylene terephthalate), poly(1,4-butylene adipate-co-1,4-butylene sebacate-co-1,4-butylene terephthalate), poly(1,4-butylene azelate-co-1,4-butylene sebacate-co-1,4-butylene terephthalate), poly(1,4-butyleneadipate-co-1,4-butylene-azelate-co-1,4-butylene-terephthalate), poly(1,4-butylenesuccinate-co-1,4-butylenesebacate-co-1,4-butylene terephthalate), poly(1,4-butyleneadipate-co-1,4-butylene succinate-co-1,4-butylene terephthalate), poly(1,4-butyleneazelate-co-1,4-butylene succinate-co-1,4-butylene terephthalate).

19. The multilayer film according to claim 2 in which the lactic acid polyester (component iii.) contains at least 95% by weight of repetitive units derived from L-lactic or D-lactic acid or combinations thereof, with a molecular weight Mw of more than 50000 and shear viscosity comprised between 50÷250 Pa*s (measured according to ASTM standard D3835 at T=190° C., shear rate=1000 s·1, D=1 mm, L/D=10).

20. The multilayer film according to claim 3 in which the lactic acid polyester (component iii.) contains at least 95% by weight of repetitive units derived from L-lactic or D-lactic acid or combinations thereof, with a molecular weight Mw of more than 50000 and shear viscosity comprised between 50÷250 Pa*s (measured according to ASTM standard D3835 at T=190° C., shear rate=1000 s·1, D=1 mm, L/D=10).
